(19) United States
(12) Patent Application Publication
(10) Pub. No.: US 2020/0097381 A1
(43) Pub. Date: Mar. 26, 2020

(54) DATA PROCESSING METHOD, DATA PROCESSING DEVICE, DATA PROCESSING SYSTEM, AND NON-TRANSITORY COMPUTER-READABLE RECORDING MEDIUM

(71) Applicant: SCREEN HOLDINGS CO., LTD., Kyoto (JP)

(72) Inventors: Hideji NAOHARA, Kyoto (JP); Mayumi YAMAMOTO, Kyoto (JP)

(73) Assignee: SCREEN HOLDINGS CO., LTD., KYOTO (JP)

(21) Appl. No.: 16/554,528

(22) Filed: Aug. 28, 2019

(30) Foreign Application Priority Data
Sep. 20, 2018 (JP) 2018-176257

(51) Int. Cl. G06F 11/30; G06F 11/34; G06F 17/18

(52) U.S. Cl. CPC G06F 11/3058; G06F 17/18; G06F 11/3452

(57) ABSTRACT

A data processing method which processes a plurality of unit processing data (each unit processing data include plural types of time-series data) includes: a unit processing data selection step in which two or more processing data are selected from the plurality of unit processing data; a first evaluation value calculation step in which evaluation values of each time-series datum included in selected unit processing data which are the unit processing data selected in the unit processing data selection step are calculated; and a first evaluation value distribution creation step in which evaluation value distributions showing degrees of each value of the evaluation values are created for each type of the time-series data based on the evaluation values of each time-series datum calculated in the first evaluation value calculation step.

### CROSS REFERENCE TO RELATED APPLICATIONS

This application claims the priority benefit of Japanese Patent Application No. 2018-176257, filed on Sep. 20, 2018. The entirety of the above-mentioned patent application is hereby incorporated by reference herein and made a part of this specification.

### BACKGROUND

### Technical Field

The disclosure relates to a digital data processing, in particular, to a method for processing time-series data.

### Related Art

As a method for detecting abnormalities of machines or devices, the following method is known in which physical quantities (for example, length, angle, time, speed, force, pressure, voltage, current, temperature, flow rate and the like) showing an operating state of the machine or the device are measured using a sensor or the like and time-series data obtained by arranging measurement results in an order of generation is analysed. When the machine or the device carries out the same operation under the same condition, the time-series data change similarly if there is no abnormality. Therefore, places where abnormalities occur and causes of the abnormalities can be specified by comparing a plurality of time-series data changing similarly with each other to detect abnormal time-series data and analysing the abnormal time-series data. In addition, recently, improvements of data processing ability of computers are remarkable. Therefore, there are many cases in which required results are obtained in a practical time even if a data amount is enormous. Given this situation, analysis of time series data also becomes popular.

For example, in the field of manufacturing of a semiconductor substrate, the analysis of time-series data also becomes popular. In a manufacturing process of the semiconductor substrate (referred to as “substrate” hereinafter), a series of processing is performed by a substrate processing device. The substrate processing device includes a plurality of processing units for carrying out specific processing of the series of processing on the substrate. Each processing unit processes the substrate according to a predetermined procedure (referred to as “recipe”). At this time, time-series data are obtained based on measurement results of each processing unit. The processing unit in which an abnormality occurs or a cause of the abnormality can be specified by analyzing the obtained time-series data. Besides, the term “recipe” refers to not only the procedures carried out on the substrate, but also preprocessing carried out before the processing of the substrate, or the processing for carrying out maintenance and management of the state of the processing unit or carrying out various measurements relating to the processing units while the processing to the substrate is not carried out by the processing units. However, in the present specification, attention is paid to the processing carried out on the substrates. Furthermore, the invention which is related to calculation of abnormality degrees of time-series data obtained by the manufacturing of the substrate is disclosed in Japanese Laid-Open No. 2017-83985.

Generally, in the manufacturing process of a substrate, time-series data of an enormous number of parameters (various physical quantities) are obtained by implementation of recipes. The time-series data are data obtained by measuring the various physical quantities (for example, flow rate or temperature of processing fluid supplied from a nozzle, humidity in a chamber, internal pressure of the chamber, exhaust pressure of the chamber, and the like) using a sensor or the like when the recipes are implemented and arranging measurement results in time series. In addition, data obtained by applying analysis to an image taken by a camera are also the time series data. Then, judgment on whether each time-series datum is abnormal is carried out by comparing data values of the time-series data with threshold values, or by comparing values calculated according to a given calculation rule from the data values with the threshold values. Furthermore, a threshold value is set for each parameter.

However, the work to define the threshold values for each parameter is very complicated work, and it is very difficult to obtain a suitable threshold value for each of the enormous number of parameters. In addition, since the threshold values that are set are not necessarily suitable values, accuracy of the abnormality judgment is not good. That is, according to the conventional method, the abnormalities of the time-series data cannot be detected with high accuracy.

Therefore, the disclosure provides a data processing method capable of carrying out, with better accuracy than before, an abnormality detection that uses time-series data without requiring complicated work of a user.

### SUMMARY

According to one embodiment of the disclosure, a data processing method is provided, in which a plurality of types of time-series data obtained by unit processing is taken as unit processing data and a plurality of unit processing data is processed. The method includes a unit processing data selection step, in which two or more unit processing data are selected from the plurality of unit processing data; a first evaluation value calculation step, in which evaluation values of each time-series datum included in selected unit processing data which are the unit processing data selected in the unit processing data selection step are calculated; and a first evaluation value distribution creation step, in which evaluation value distributions showing degrees of each value of the evaluation values are created for each type of the time-series data based on the evaluation values of each time-series datum calculated in the first evaluation value calculation step.

According to this configuration, the evaluation values of each time-series datum included in the unit processing data selected by the user are calculated. Then, the evaluation value distributions showing distributions of the evaluation values are created. Here, when time-series data are newly obtained, an abnormality detection of the time-series data can be carried out using the evaluation value distributions. At that time, for example, threshold values for carrying out abnormality judgment can be set based on a statistical value obtained from data that are creation source of the evaluation value distributions (data of the evaluation values). Based on the above, the abnormality detection that uses the time-series data can be carried out with better accuracy than before without requiring complicated work of the user.

According to another embodiment the disclosure, a data processing device is provided, which takes a plurality of types of time-series data obtained by unit processing as unit processing data and processes a plurality of unit processing data. The data processing device includes a unit processing data selection part, which selects two or more unit processing data from the plurality of unit processing data; an evaluation value calculation part, which calculates evaluation values of each time-series datum included in selected unit processing data which are the unit processing data selected by the unit processing data selection part; and an evaluation value distribution creation part, which creates evaluation value distributions showing degrees of each value of the evaluation values for each type of the time-series data based on the evaluation values of each time-series datum calculated by the evaluation value calculation part.

According to another embodiment of the disclosure, a data processing system is provided, which takes a plurality of types of time-series data obtained by unit processing implemented by substrate processing devices as unit processing data and processes a plurality of unit processing data, and which includes a plurality of substrate processing devices. The data processing system includes a unit processing data selection part, which selects two or more unit processing data from the plurality of unit processing data; an evaluation value calculation part, which calculates evaluation values of each time-series datum included in selected unit processing data which are the unit processing data selected by the unit processing data selection part; and an evaluation value distribution creation part, which creates evaluation value distributions showing degrees of each value of the evaluation values for each type of the time-series data based on the evaluation values of each time-series datum calculated by the evaluation value calculation part.

According to another embodiment of the disclosure, a non-transitory computer-readable recording medium that a data processing program is stored to make a computer, which is included in a data processing device which takes plural types of time-series data obtained by unit processing as unit processing data and processes a plurality of unit processing data, to implement: a unit processing data selection step, in which two or more unit processing data are selected from the plurality of unit processing data; an evaluation value calculation step, in which evaluation values of each time-series datum included in selected unit processing data which are the unit processing data selected in the unit processing data selection step are calculated; and an evaluation value distribution creation step, in which evaluation value distributions showing degrees of each value of the evaluation values are created for each type of the time-series data based on the evaluation values of each time-series datum calculated in the evaluation value calculation step.

### BRIEF DESCRIPTION OF THE DRAWINGS

FIG. 1 is a block diagram showing an overall configuration of a data processing system (a data processing system for a substrate processing device) according to one embodiment of the disclosure.

FIG. 2 is a diagram showing a schematic configuration of the substrate processing device in the above embodiment.

FIG. 3 is a diagram in which one certain time-series datum is graphed and shown in the above embodiment.

FIG. 4 is a diagram for illustrating unit processing data in the above embodiment.

FIG. 5 is a block diagram showing a hardware configuration of the data processing device in the above embodiment.

FIG. 6 is a diagram for illustrating evaluation value distributions in the above embodiment.

FIG. 7 is a flow chart showing an outline of an overall processing procedure of an abnormality detection that uses time-series data in the above embodiment.

FIG. 8 is a diagram showing one example of an abnormality judgment target setting screen in the above embodiment.

FIG. 9 is a diagram for illustrating judgment of abnormality degrees in the above embodiment.

FIG. 10 is a flow chart showing a specific procedure of creation of the evaluation value distributions in the above embodiment.

FIG. 11 is a diagram showing one example of a unit processing data selection screen in the above embodiment.

FIG. 12 is a diagram showing one example of a parameter specification screen (an example immediately after display) in the above embodiment.

FIG. 13 is a diagram showing one example of a parameter specification screen (an example after parameter specification by a user) in the above embodiment.

FIG. 14 is a diagram for illustrating update of the evaluation value distributions in the above embodiment.

FIG. 15 is a flow chart showing a specific procedure of creation of evaluation value distributions in a first variation example of the above embodiment.

FIG. 16 is a flow chart showing a specific procedure of creation of evaluation value distributions in a second variation example of the above embodiment.

FIG. 17 is a diagram for illustrating a median value in the second variation example of the above embodiment.

FIG. 18 is a diagram for illustrating relationships between parameters and time-series data in a third variation example of the above embodiment.

FIG. 19 is a flow chart showing an outline of an overall processing procedure of an abnormality detection that uses time-series data in a fourth variation example of the above embodiment.

FIG. 20 is a flow chart showing a specific procedure of update of evaluation value distributions in a fifth variation example of the above embodiment.

FIG. 21 is a diagram for illustrating creation of distributions of evaluation values for each processing unit in the fifth variation example of the above embodiment.

FIG. 22 is a diagram for illustrating that the evaluation values are considered in addition to variations in the fifth variation example of the above embodiment.

FIG. 23 is a diagram showing a configuration example of a data processing system (an example in which there is a plurality of data processing devices) in a sixth variation example of the above embodiment.

FIG. 24 is a diagram showing a configuration example of a data processing system (an example in which there is only one data processing device) in the sixth variation example of the above embodiment.

### DESCRIPTION OF THE EMBODIMENTS

In the following, one embodiment of the disclosure is described with reference to attached drawings.

### 1. Overall Configuration

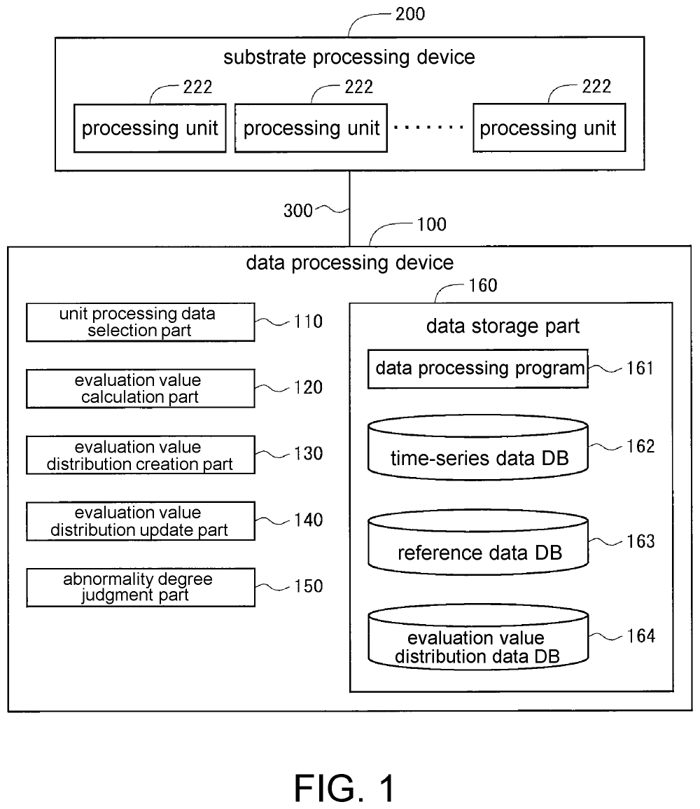

FIG. 1 is a block diagram showing an overall configuration of a data processing system (a data processing system for a substrate processing device) according to one embodiment of the disclosure. The data processing system is configured by a data processing device 100 and a substrate processing device 200. The data processing device 100 and the substrate processing device 200 are connected to each other by a communication line 300.

The data processing device 100 functionally has a unit processing data selection part 110, an evaluation value calculation part 120, an evaluation value distribution creation part 130, an evaluation value distribution update part 140, an abnormality degree judgment part 150 and a data storage part 160. The unit processing data selection part 110 selects two or more unit processing data from a plurality of unit processing data described later which is already accumulated. The evaluation value calculation part 120 carries out calculation of evaluation values for judgments of abnormality degrees of time-series data obtained in substrate processing. For example, the evaluation value calculation part 120 calculates the evaluation values of each time-series datum included in the unit processing data selected by the unit processing data selection part 110. The evaluation value distribution creation part 130 creates evaluation value distributions described later based on the evaluation values (the evaluation value of each time-series datum) calculated by the evaluation value calculation part 120. The evaluation value distribution update part 140 carries out update of the evaluation value distributions. The abnormality degree judgment part 150 judges, under the condition that the evaluation value distributions already exist, abnormality degrees of time-series data newly obtained by implementing the recipes by the substrate processing device 200 based on the evaluation values of the time-series data and the evaluation value distributions. Furthermore, in the embodiment, it is assumed that as a result of the substrate processing, a smaller value of the evaluation values is better.

In the data storage part 160, a data processing program 161 for implementing various processing in the embodiment is held. Besides, the data storage part 160 includes a time-series data DB 162 for storing the time-series data sent from the substrate processing device 200, a reference data DB 163 for storing reference data, and an evaluation value distribution data DB 164 for storing evaluation value distribution data. The reference data and the evaluation value distribution data are described later. Furthermore, “DB” is short for “data base”.

The substrate processing device 200 includes a plurality of processing units 222. In each processing unit 222, a plurality of physical quantities showing an operating state of this processing unit 222 is measured. In this way, a plurality of time-series data (more specifically, time-series data of a plurality of parameters) is obtained. The time-series data obtained by the processing in each processing unit 222 are sent to the data processing device 100 from the substrate processing device 200 and stored in the time-series data DB 162 as described above.

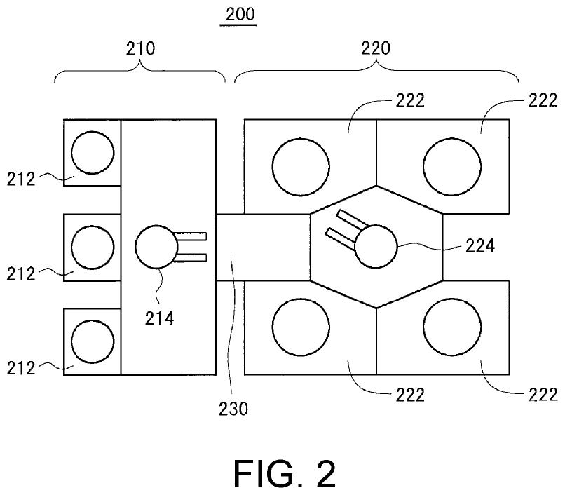

FIG. 2 is a diagram showing a schematic configuration of the substrate processing device 200. The substrate processing device 200 includes an indexer part 210 and a processing part 220. The indexer part 210 and the processing part 220 are controlled by a control part (not shown in the diagrams) inside the substrate processing device 200.

The indexer part 210 includes a plurality of substrate container holding parts 212 where substrate containers (cassettes) capable of containing plural pieces of substrates are placed, and an indexer robot 214 that takes the substrates out from the substrate containers and carries the substrates into the substrate containers. The processing part 220 includes a plurality of processing units 222 that uses processing solution to carry out the processing such as cleaning of the substrates or the like, and a substrate conveyance robot 224 that carries the substrates to the processing units 222 and takes the substrates out from the processing units 222. The number of the processing units 222 is for example 12. In this case, for example, a tower structure in which three processing units 222 are laminated is arranged, as shown in FIG. 2, in four places around the substrate conveyance robot 224. In each processing unit 222, a chamber which is a space for carrying out the processing to the substrates is arranged, and the processing solution is supplied to the substrates within the chamber. Furthermore, each processing unit 222 includes one chamber. That is, the processing units 222 and the chambers are in a one to one correspondence.

When the processing to the substrates is carried out, the indexer robot 214 takes out the substrate which is a processing target from the substrate containers placed on the substrate container holding parts 212, and delivers the substrate to the substrate conveyance robot 224 via a substrate delivery part 230. The substrate conveyance robot 224 carries the substrate received from the indexer robot 214 to a target processing unit 222. When the processing to the substrate ends, the substrate conveyance robot 224 takes out the substrate from the target processing unit 222 and delivers the substrate to the indexer robot 214 via the substrate delivery part 230. The indexer robot 214 carries the substrate received from the substrate conveyance robot 224 to a target substrate container.

In the data processing system, each time the recipes are implemented in order to detect abnormalities of machines related to the processing in each processing unit 222 or abnormalities of the processing carried out in each processing unit 222, and the like, time-series data are obtained. The time-series data obtained in the embodiment are data obtained by measuring various physical quantities (for example, flow rate or temperature of a processing fluid supplied from a nozzle, humidity in the chambers, internal pressure of the chambers, exhaust pressure of the chambers, and the like) using a sensor or the like when the recipes are implemented and arranging measurement results in time series. In addition, data that are obtained by applying analysis to an image taken by a camera and arranged in time series are also time series data. The various physical quantities are processed as values of respectively corresponding parameters. Furthermore, one parameter corresponds to one type of physical quantity.

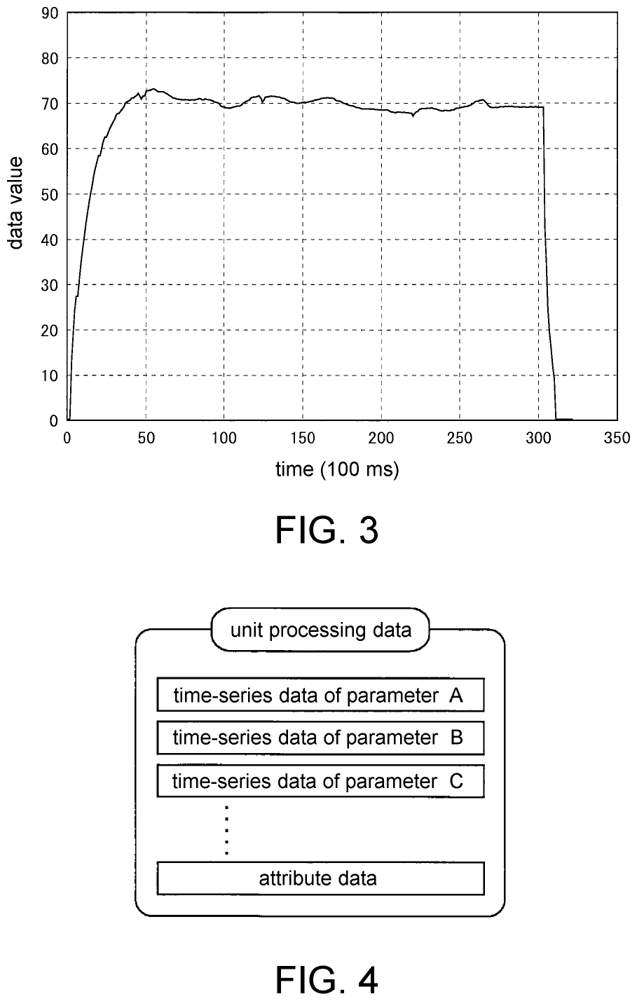

FIG. 3 is a diagram in which one certain time-series datum is graphed and shown. The time-series datum is a datum of certain physical quantity and obtained by the processing to one piece of substrate in the chamber within one processing unit 222 when one recipe is implemented. Furthermore, the time-series datum is a datum configured by a plurality of discrete values, and in FIG. 3, a straight line is made between two datum values adjacent in terms of time. Meanwhile, when one recipe is implemented, the time-series data of various physical quantities are obtained in each processing unit 222 in which the recipes are implemented. Therefore, in the following, the processing carried out to one piece of substrate in the chamber within one processing unit 222 when one recipe is implemented is called “unit processing”, and a group of time-series data obtained by the unit processing is called “unit processing data”. In one unit processing data, as schematically shown in FIG. 4, the time-series data of a plurality of parameters and attribute data consisting of data of a plurality of items (for example, start time of the processing, end time of the processing and the like) and the like for specifying the unit processing data are included. Furthermore, relating to FIG. 4, a “parameter A”, a “parameter B”, and a “parameter C” correspond to mutually different types of physical quantities.

In order to detect the abnormalities of the machines or the processing, the unit processing data obtained by implementation of the recipes should be compared with unit processing data having ideal data values as processing results. More specifically, the plurality of time-series data included in the unit processing data obtained by the implementation of the recipes should be respectively compared with a plurality of time-series data included in the unit processing data having the ideal data values as the processing results. Therefore, in the embodiment, relating to each recipe, the unit processing data (the unit processing data consisting of the plurality of time-series data to be respectively compared with the plurality of time-series data included in the unit processing data which are the evaluation targets) to be compared with the unit processing data which are evaluation targets is determined as reference data (data which are reference at the time of calculating the evaluation values). The reference data are stored in the above-described reference data DB 163 (see FIG. 1).

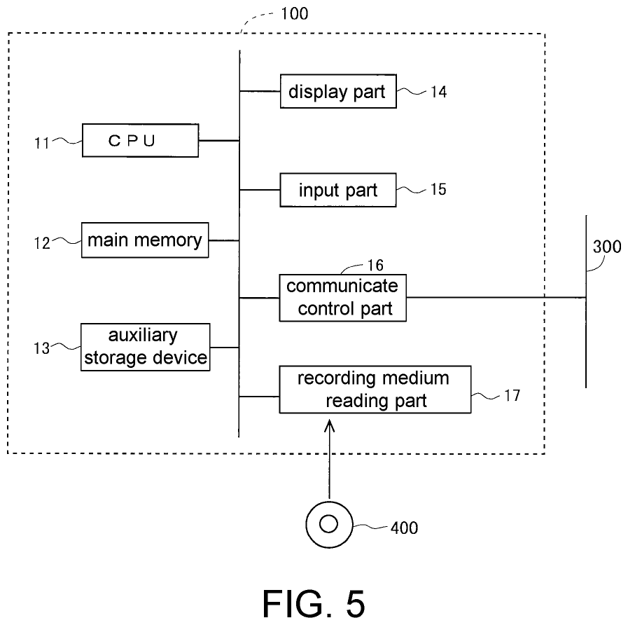

Here, a hardware configuration of the data processing device 100 is described with reference to FIG. 5. The data processing device 100 includes a CPU 11, a main memory 12, an auxiliary storage device 13, a display part 14, an input part 15, a communication control part 16 and a recording medium reading part 17. The CPU 11 carries out various arithmetic processing or the like according to given instructions. The main memory 12 temporarily stores programs being implemented or data. The auxiliary storage device 13 stores various program and various data which should be held even if electric power source is off. The data storage part 160 described above is achieved by the auxiliary storage device 13. The display part 14 displays, for example, various screens for an operator to carry out works. For example, a liquid crystal display is used for the display part 14. The input part 15 is, for example, a mouse, a keyboard or the like, and accepts input from outside by the operator. The communication control part 16 controls data transmission and reception. The recording medium reading part 17 is an interface circuit of a recording medium 400 recording the programs and the like. For example, a non-transitory recording medium such as a CD-ROM or a DVD-ROM is used for the recording medium 400.

When the data processing device 100 is started, a data processing program 161 (see FIG. 1) held in the auxiliary storage device 13 (the data storage part 160) is read into the main memory 12, and the CPU 11 implements the data processing program 161 read into the main memory 12. In this way, a function of carrying out various data processing is provided by the data processing device 100. Furthermore, the data processing program 161 is provided, for example, in a form of being recorded in the recording medium 400 such as a CD-ROM or a DVD-ROM or in a form of download via the communication line 300.

### 2. Evaluation of Substrate Processing

### 2.1 Evaluation Value Distribution

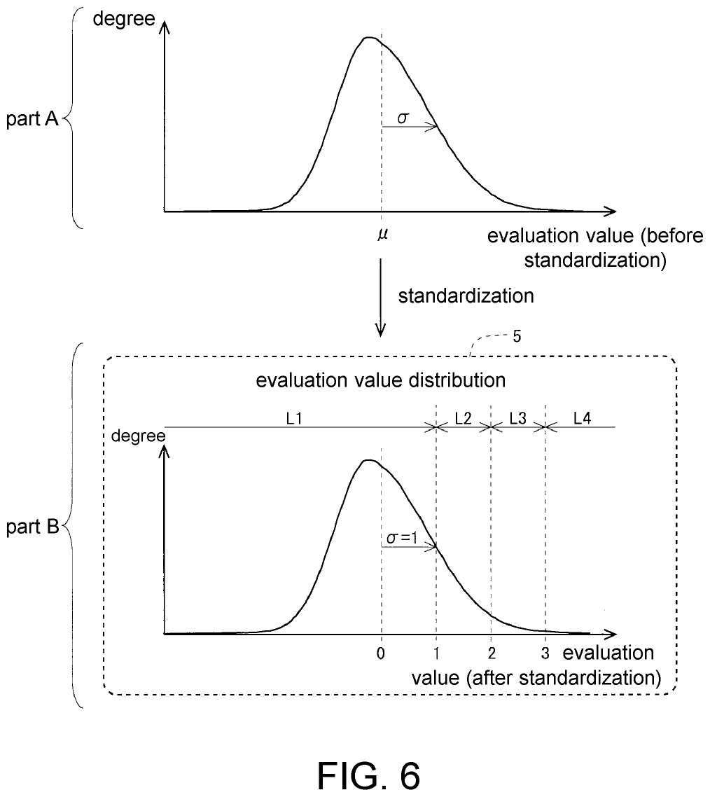

In the embodiment, in order to carry out abnormality judgment of each time-series datum, the evaluation value distributions showing degrees of each value of the evaluation values obtained by the evaluation value calculation part 120 are used. The evaluation value distributions are described specifically with reference to FIG. 6.

The evaluation value distributions are prepared for each parameter (that is, each type of the time-series data). When attention is paid to one certain parameter, a distribution showing the degrees of each evaluation value of the time-series data is, for example, as shown by part A of FIG. 6. As for part A of FIG. 6, μ represents an average value of evaluation values that are generation source of the distribution, and σ represents a standard deviation of the evaluation values that are generation source of the distribution. Here, a distribution (a distribution in which the average value is 0 and a variance or a standard deviation is 1) as shown in part B of FIG. 6 can be created as an evaluation value distribution 5 by standardizing each of the evaluation values that are generation source of the distribution. Furthermore, if the evaluation values before the standardization are set as Sold, and the evaluation values after the standardization are set as Snew, the standardization is carried out by the following equation (1).

$$Snew = \frac{Sold - μ}{σ} \qquad ( 1 )$$

If time-series data are newly generated by the implementation of the recipes under a condition that the evaluation value distribution 5 as described above is prepared, the evaluation values of the time-series data are obtained. Then, the standardization based on the above equation (1) is carried out with respect to the obtained evaluation values using the average value μ and the standard deviation σ at the time of creating the evaluation value distribution 5. Abnormality degrees of the time-series data are determined based on the evaluation values obtained by the standardization.

As for determination of the abnormality degrees, in the embodiment, a range of the evaluation values after the standardization is divided into four zones. That is, the abnormality degrees of each time-series datum are judged at four levels. Specifically, as shown in part B of FIG. 6, if the evaluation values (after the standardization) are less than 1, the abnormality degrees are judged as level 1 (L1); if the evaluation values are more than 1 and less than 2, the abnormality degrees are judged as level 2 (L2); if the evaluation values are more than 2 and less than 3, the abnormality degrees are judged as level 3 (L3); and if the evaluation values are more than 3, the abnormality degrees are judged as level 4 (L4).

Meanwhile, the division of the evaluation values after the standardization into four zones is carried out based on standard deviations. That is, threshold values between the zones are automatically determined. Therefore, different from the conventional situation, complicated work in which a user sets the threshold values in order to carry out the abnormality judgment of the time-series data is not required.

### 2.2 Overall Processing Flow

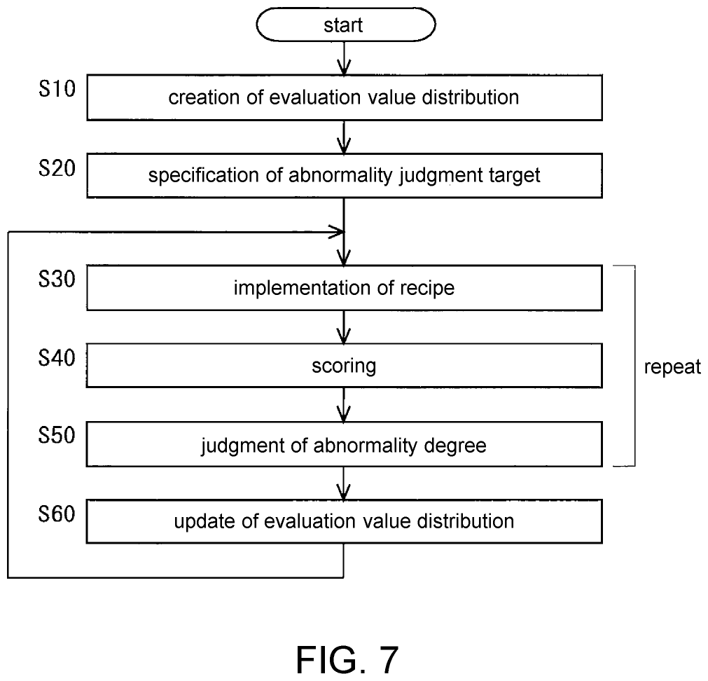

FIG. 7 is a flow chart showing an outline of an overall processing procedure of an abnormality detection that uses the time-series data. Furthermore, it is assumed that a certain number of time-series data have already been accumulated before the processing starts.

At first, in order to realize the abnormality detection (the abnormality judgment of each time-series datum) that uses the time-series data, the creation of the evaluation value distribution 5 described above is carried out (step S10). In the embodiment, the evaluation value distribution 5 common to all the processing units 222 is created for each parameter. A specific procedure of the creation of the evaluation value distribution 5 is described later.

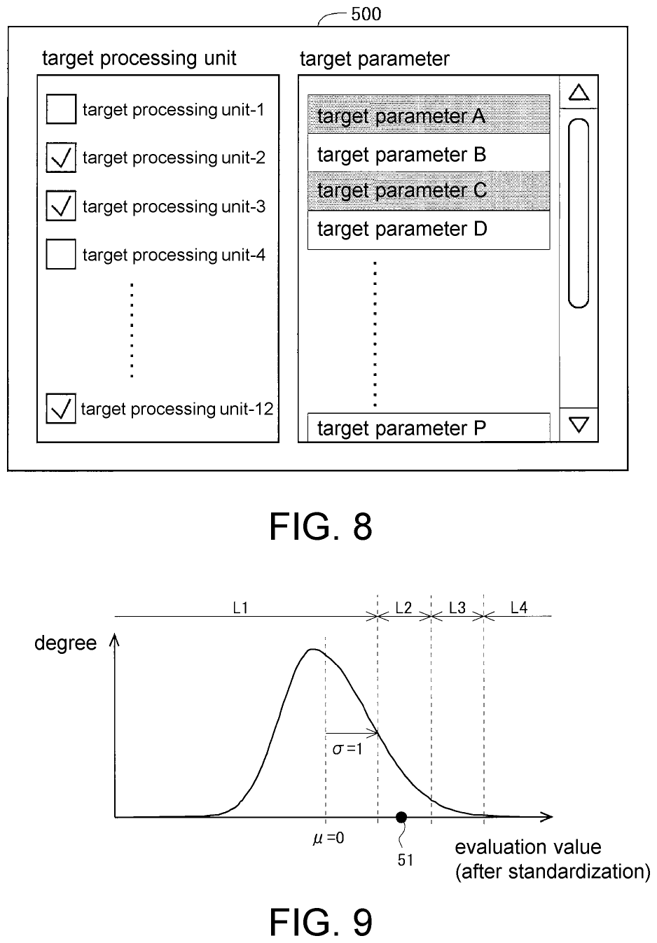

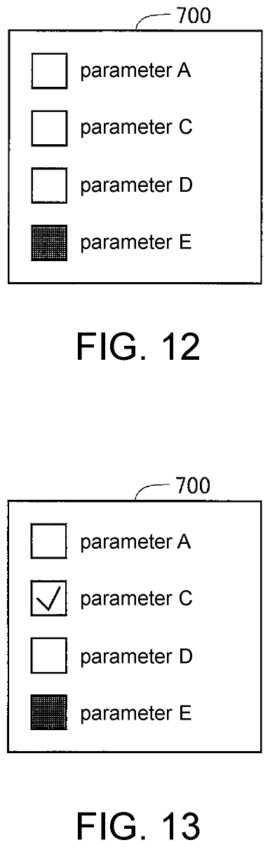

Next, the processing units (the chambers) and the parameters which are the targets of the abnormality judgment are specified by the user (step S20). At this time, in the display part 14 of the data processing device 100, for example, an abnormality judgment target setting screen 500 (in FIG. 8, only one part of the actually displayed screen is shown; the same applies to FIG. 11, FIG. 12, and FIG. 13) as shown in FIG. 8 is displayed, and the user specifies the processing units and the parameters which are the targets of the abnormality judgment. In the example shown in FIG. 8, the processing units for which check boxes become selected states and the parameters which are in selected states within list boxes are specified as the targets of the abnormality judgment. Furthermore, in step S10, the evaluation value distributions 5 of all the parameter are created using the time-series data obtained in the processing in all the processing units 222, but only the time-series data of the parameters specified in step S20 among the time-series data obtained by the processing in the processing units specified in step S20 are targets to which the abnormality judgment is actually carried out.

Then, if the recipes are implemented by the substrate processing device 200 (step S30), scoring of the time-series data which are the abnormality judgment targets among the time-series data obtained by the implementation of the recipes is carried out (step S40). Furthermore, the scoring is the processing in which each time-series datum is compared with the reference data and results obtained thereby are quantified as the evaluation values. After the scoring ends, judgment of the abnormality degree is carried out using corresponding evaluation value distribution 5 for each time-series datum (step S50). In step S50, at first, the evaluation values obtained in step S40 are standardized. When the standardization of the evaluation values is carried out by the above equation (1), the average value μ and the standard deviation σ obtained at the time of the creation of the evaluation value distribution 5 is used as the average value μ and the standard deviation σ in the above equation (1). Then, the abnormality degrees are determined based on positions of the evaluation values after the standardization on the evaluation value distribution 5. For example, if an evaluation value after the standardization is a value in the position denoted by symbol 51 in FIG. 9, the abnormality degree of the time-series datum is judged as “level 2”.

In the embodiment, the processing of step S30-step S50 is repeated until there is a change in contents of any one of the recipes. That is, the judgment of abnormality degrees when a certain recipe is implemented is carried out using the same evaluation value distribution 5 until there is a change in the contents of the recipe. If there is a change in the contents of any one of the recipes, update of the evaluation value distributions 5 is carried out (step S60). An evaluation value distribution update step is achieved by this step S60. According to the embodiment, because the update of the evaluation value distribution is carried out in this way, for example, the abnormality detection that uses the time-series data can be carried out while considering recent trends. Furthermore, the update of the evaluation value distributions 5 is specifically described later. After the update of the evaluation value distributions 5, the processing returns to step S30.

### 3. Creation Method of Evaluation Value Distributions

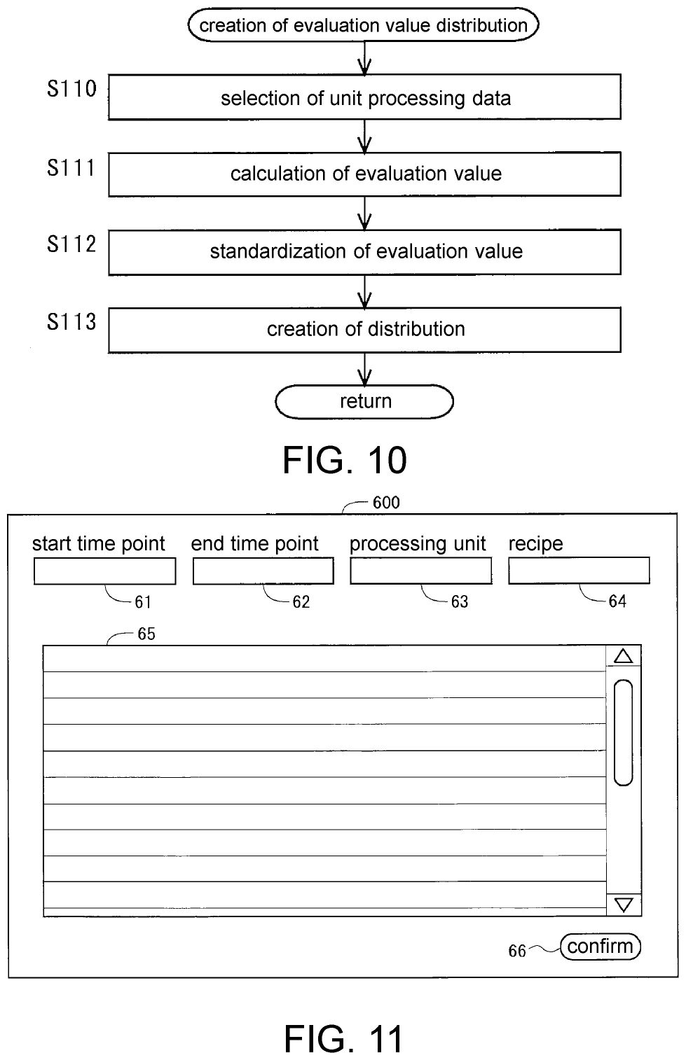

A specific procedure of the creation of the evaluation value distributions 5 in the embodiment (step S10 of FIG. 7) is described with reference to FIG. 10. At first, two or more unit processing data which are creation sources of the evaluation value distributions 5 are selected by the user (step S110). In step S110, in the display part 14 of the data processing device 100, for example, a unit processing data selection screen 600 as shown in FIG. 11 is displayed. In the unit processing data selection screen 600, a start time point input box 61, an end time point input box 62, a processing unit specification box 63, a recipe specification box 64, an extraction data display region 65, and a confirmation button 66 are included. The start time point input box 61 and the end time point input box 62 are list boxes in which date and time can be specified, and the processing unit specification box 63 and the recipe specification box 64 are list boxes in which one or more items can be selected from a plurality of items. The user specifies periods by the start time point input box 61 and the end time point input box 62, specifies the processing units by the processing unit specification box 63, and specifies the recipes by the recipe specification box 64. In this way, a list of unit processing data satisfying the specified conditions is displayed in the extraction data display region 65. The user presses the confirmation button 66 in a state that one part of or all of the unit processing data displayed in the extraction data display region 65 are selected. In this way, the unit processing data which are the creation sources of the evaluation value distributions 5 are confirmed. Furthermore, not all of the periods, the processing units, and the recipes are required to be specified, and at least one of the periods, the processing units, and the recipes may be specified.

Next, the evaluation values are calculated for each time-series datum included in the unit processing data selected in step S110 (referred to as “selected unit processing data” hereinafter) (step S111). In the embodiment, the reference data are held in the reference data DB 163 in advance. That is, the reference data which are to be compared with each time-series datum included in the selected unit processing data are held in the reference data DB 163. Therefore, in step S111, each time-series datum included in the selected unit processing data is compared with the reference data held in the reference data DB 163 (see FIG. 1), and the evaluation values of each time-series datum are calculated.

Then, the evaluation values calculated in step S111 are standardized (step S112). As described above, the evaluation values are standardized using the above equation (1). Meanwhile, because the evaluation value distributions 5 are created for each parameter, the average value μ and the standard deviation σ in the above equation (1) are obtained for each parameter.

At last, for each parameter (that is, each type of the time-series data), the evaluation value distribution 5 is created based on the data of the evaluation values after the standardization (step S113). The data configuring the evaluation value distributions 5 are held as evaluation value distribution data in the above-described evaluation value distribution data DB 164 (see FIG. 1).

Furthermore, in the embodiment, a unit processing data selection step is achieved by step S110, a first evaluation value calculation step is achieved by step S111, and a first evaluation value distribution creation step is achieved by step S112 and step S113.

### 4. Update Method of Evaluation Value Distributions

Next, the update of the evaluation value distributions 5 is described. In the unit processing data obtained by implementing the recipes by the substrate processing device 200, the time-series data of a plurality of parameters are included. As described above, in the embodiment, the evaluation value distributions 5 are created for each parameter. Meanwhile, in the substrate processing device 200, the contents of the recipes may be changed. If there is a change in the contents of the recipes, before and after the change, contents of the time-series data obtained by the implementation of the recipes are different. At this time, if the abnormality judgment of the time-series data obtained after the change of the recipes is carried out using the evaluation value distributions 5 created before the change of the recipes, there is a risk that correct results cannot be obtained as the results of the abnormality judgment. Therefore, in the embodiment, when there is a change in the contents of the recipes, the update of the evaluation value distributions 5 is carried out. Furthermore, immediately after the change in the contents of the recipes, time-series data based on the contents after the change are not accumulated, and thus the update of the evaluation value distributions 5 may be carried out after the time-series data based on the contents after the change are accumulated to a certain extent.

At the time of the update of the evaluation value distributions 5, the evaluation value distribution update part 140 compares the parameters corresponding to the recipes before the change with the parameters corresponding to the recipes after the change. Then, the evaluation value distribution update part 140 creates evaluation value distributions 5 corresponding to the parameters added along with the change of the contents of the recipes based on the data of the evaluation values already accumulated (the evaluation values of the time-series data of the parameters). In addition, the specification of the parameters in which there is a change in the contents is carried out by the user, and the evaluation value distribution update part 140 recreates the evaluation value distributions 5 corresponding to the specified parameters.

For example, it is assumed that a parameter group corresponding to the recipes changes as described later due to the change of the contents of the recipes.

Before the change: parameter A, parameter B, parameter C, parameter D

After the change: parameter A, parameter C, parameter D, parameter E

Furthermore, it is assumed that for the parameter A and the parameter D, there is no change in the contents of the time series data, and for the parameter C, there is a change in contents of time series data.

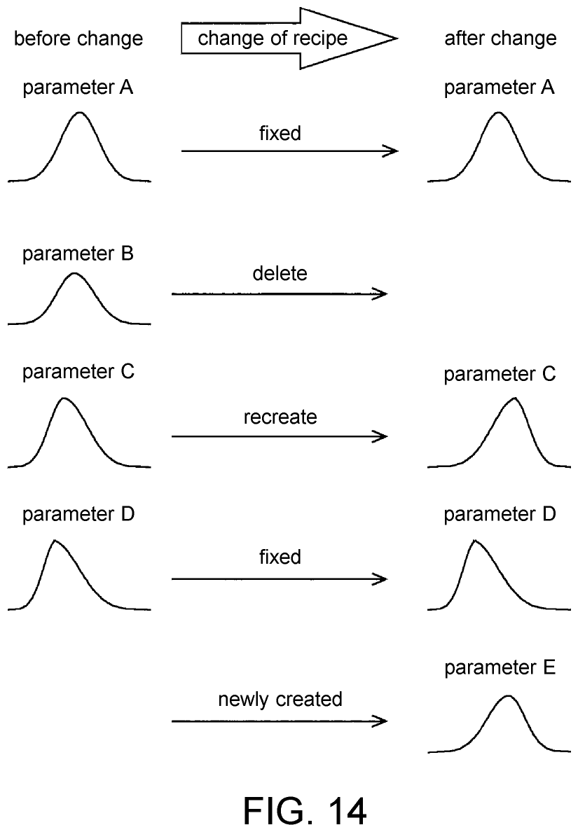

In the case of the above example, at the time of the update of the evaluation value distributions 5, in the display part 14 of the data processing device 100, for example a parameter specification screen 700 as shown in FIG. 12 is displayed. In the parameter specification screen 700, check boxes corresponding to a parameter group after the change (the parameter A, the parameter C, the parameter D, and the parameter E) are included. The check box corresponding to the parameter E which is the parameter added along with the change of the content of the recipes is in a selected-in-advance state (a shading state in FIG. 12). In the parameter specification screen 700, because there is a change in the contents of the time-series data for the parameter C, as shown in FIG. 13, the user selects the check box corresponding to the parameter C. In this way, after the user specifies the parameter, the update of the evaluation value distributions 5 is actually carried out. As a result, the evaluation value distributions 5 are updated as schematically shown in FIG. 14. Specifically, the evaluation value distribution 5 for the parameter B which is a parameter deleted along with the change of the contents of the recipes is deleted, the evaluation value distribution 5 for the parameter E which is a parameter added along with the change of the contents of the recipes is newly created, and the evaluation value distribution 5 for the parameter C which is a parameter specified by the user is recreated. Furthermore, the evaluation value distributions 5 for the parameter A and the parameter D maintain the state before the change of the contents of the recipes.

As described above, only the evaluation value distributions 5 for the parameters relating to the change of the contents of the recipes are updated (created, recreated, or deleted). In this way, it can be prevented that the update of the evaluation value distributions 5 requires a great deal of time.

### 5. Effects

According to the embodiment, the evaluation values of each time-series datum included in the unit processing data selected by the user are calculated. Then, statistical standardization is performed on the evaluation values, and evaluation value distributions 5 showing the distributions of evaluation values after the standardization are created. If time-series data are newly generated by the implementation of the recipes under the condition that the evaluation value distributions 5 are created in the abovementioned manner, relating to the time-series data, abnormality degrees are determined based on positions of the evaluation values on the evaluation value distributions 5 (specifically, values after the standardization of the evaluation values obtained by the scoring). Relating to this, the evaluation value distributions 5 are distributions created based on the standardized data, and thus the threshold values at the time of the abnormality judgment can be automatically determined based on the standard deviations. That is, the threshold values for carrying out the abnormality judgment can be objectively set without complicated work of the user. In addition, by objectively setting the threshold values in this way, the abnormality judgment of the time-series data can be carried out with stable accuracy. As described above, according to the embodiment, the abnormality detection that uses the time-series data can be carried out with better accuracy than before without complicated work of the user.

### 6. Variation Examples

In the following, variation examples of the above embodiment are described.

### 6.1 Variation Examples Relating to Creation of Evaluation Value Distributions

In the above embodiment, when the creation of the evaluation value distributions 5 is started, the reference data have already been determined relating to each recipe. However, there are also cases in which the reference data as described above are not determined depending on the data processing system. Therefore, as a first variation example to a third variation example, creation methods of the evaluation value distributions 5 in the cases in which reference data are not determined in advance are described.

### 6.1.1 First Variation Example

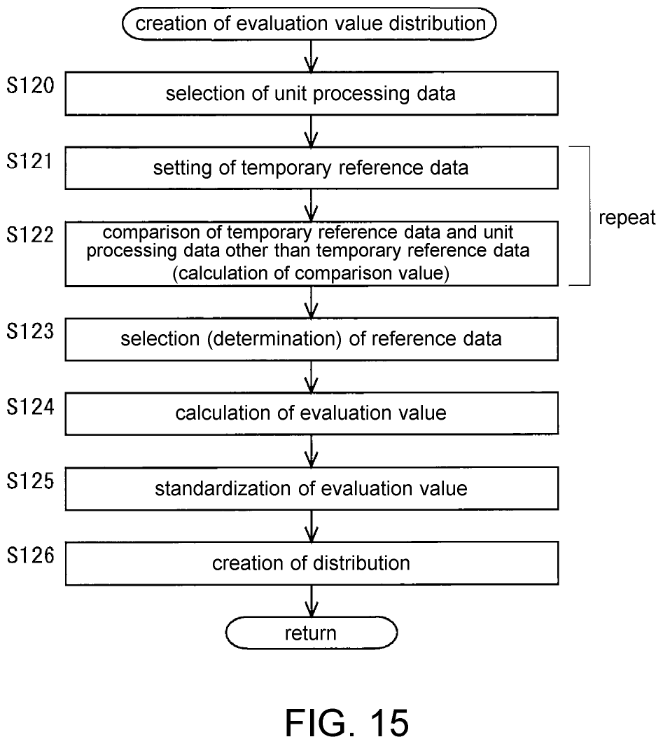

A specific procedure of the creation of the evaluation value distributions 5 in this variation example (step S10 in FIG. 7) is described with reference to FIG. 15. At first, two or more unit processing data which are creation sources of the evaluation value distributions 5 are selected by the user (step S120). In step S120, the unit processing data are selected in the same way as in step S110 in the above embodiment (see FIG. 10). That is, two or unit processing data are selected from the unit processing data extracted by specifying at least one of periods, processing units, and recipes.

Next, one of the selected unit processing data (the unit processing data selected in step S120) is determined as temporary reference data (step S121). Then, average values (or total values) of “a plurality of evaluation values” obtained by comparing the temporary reference data with each of the unit processing data other than the temporary reference data in the selected unit processing data are obtained for each parameter (step S122). If the time-series data of 10 parameters are included in the selected unit processing data, 10 data of the average values are obtained in step S122. Then, the total of these 10 data (data of the average values) is seen as a comparison value. By repeating step S121 and step S122, data of the comparison values with a number equal to the number of the unit processing data included in the selected unit processing data are obtained. If 50 unit processing data are included in the selected unit processing data, the processing of step S121 and step S122 are repeated for 50 times, and 50 data of the comparison value are obtained.

After the data of the comparison values with a number equal to the number of the unit processing data included in the selected unit processing data are obtained, reference data are determined (step S123). Specifically, the unit processing data which are set as the temporary reference data corresponding to the smallest comparison value among a plurality of comparison values obtained by repeating step S121 and step S122 are selected as the reference data. In other words, the unit processing data which are determined as the temporary reference data when the comparison value obtained in step S122 is the smallest are selected as the reference data.

After the reference data is determined, evaluation values are calculated for each time-series datum included in the selected unit processing data (step S124). In step S124, each time-series datum included in the selected unit processing data is compared with the reference data selected in step S123, and the evaluation values of each time-series datum are calculated.

After that, the evaluation values are standardized in the same way as in step S112 in the above embodiment (step S125); in addition, the evaluation value distributions 5 are created in the same way as in step S113 in the above embodiment (step S126).

Furthermore, in the variation example, the unit processing data selection step is achieved by step S120, a reference data selection step is achieved by steps S121-S123, the first evaluation value calculation step is achieved by step S124, and the first evaluation value distribution creation step is achieved by step S125 and step S126. In addition, a temporary reference data setting step is achieved by step S121, and a comparison value calculation step is achieved by step S122.

According to the variation example, in a case that the reference data are not determined in advance, the evaluation value distributions 5 used in abnormality judgment of time-series data are created. In addition, when the evaluation value distributions 5 are created, by setting all the selected unit processing data as the temporary reference data once, the most suitable unit processing data to be actually set as the reference data are determined. Because the evaluation value distributions 5 are created after the reference data are set appropriately in this way, the abnormality judgment that uses the evaluation value distributions 5 has high accuracy. As described above, according to the variation example, even in the case that the reference data are not defined in advance, the evaluation value distributions 5 can be created so that the abnormality judgment of the time-series data can be carried out with high accuracy.

### 6.1.2 Second Variation Example

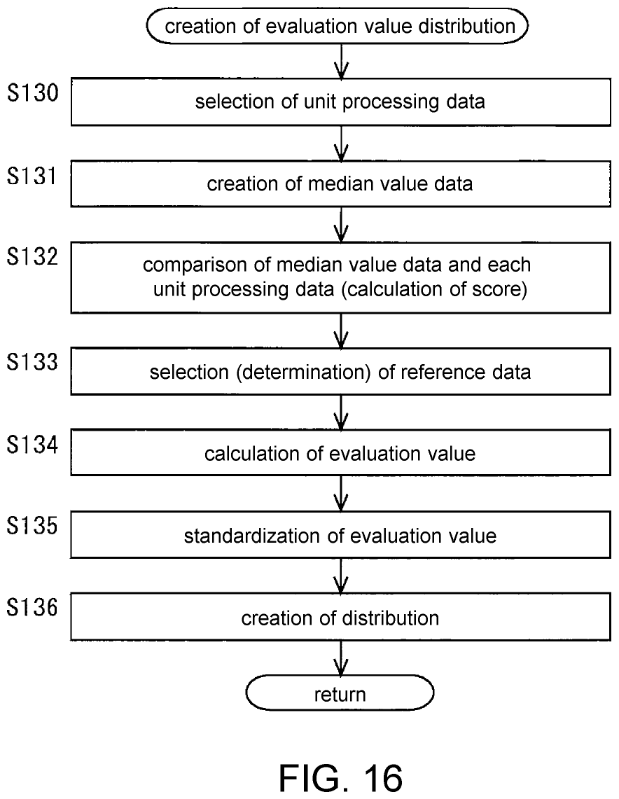

A specific procedure of the creation of the evaluation value distributions 5 in this variation example (step S10 in FIG. 7) is described with reference to FIG. 16. At first, two or unit processing data which are the creation sources of the evaluation value distributions 5 are selected by the user (step S130). In step S130, the unit processing data are selected in the same way as in step S110 in the above embodiment (see FIG. 10). That is, two or unit processing data are selected from the unit processing data extracted by specifying at least one of periods, processing units, and recipes.

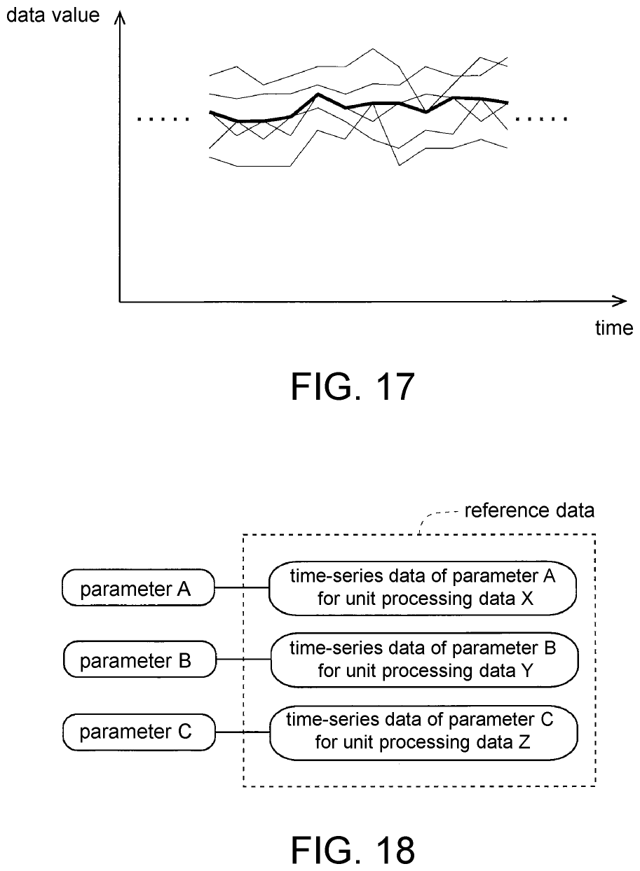

Next, for each parameter (that is, each type of time-series data), median value data which includes data of median values of the selected unit processing data at each time point are created (step S131). Relating to this, if there is an odd number of the selected unit processing data, when the data are arranged in a descending order or an ascending order, the value of the datum in the middle becomes the median value. For example, if there are five selected unit processing data, as shown in FIG. 17, the value which is the third greatest is the median value. Furthermore, in FIG. 17, the median value datum is represented by a thick solid line, and the five data which are the selected unit processing data are represented by thin solid lines. In addition, if there is an even number of the selected unit processing data, when the data are arranged in a descending order or an ascending order, a value obtained by dividing a sum of values of the two data in the middle by 2 becomes the median value. For example, if there are six selected unit processing data, the value obtained by dividing the sum of the value which is the third greatest and the value which is the fourth greatest by 2 is the median value. Then, a datum which is obtained by summarizing data of median values of all the time points becomes the median value datum. Furthermore, in place of the median value datum as described above, a representative value datum including data of center values (values obtained by dividing a sum of the smallest value and the greatest value by 2) or average values at each time point may be used in step S132 described later.

Then, evaluation values are obtained by comparing each of the selected unit processing data with the median value datum for each parameter (step S132). In the following, the evaluation values obtained in step S132 are called “scores” for convenience. After that, the reference data are determined based on data of the scores obtained in step S132 (step S133). Specifically, the selected unit processing data of which a total value of the scores obtained for each parameter (each type of the time-series data) in step S132 is the smallest (the best) are selected as reference data. If time-series data of 10 parameters are included in the selected unit processing data, 10 data of scores are obtained for each of the selected unit processing data in step S132. Then, in step S133, a total value of the 10 data of the scores is obtained for each of the selected unit processing data, and the selected unit processing data which have the smallest total value is selected as the reference data.

After the reference data are determined, the evaluation values are calculated for each time-series datum included in the selected unit processing data (step S134). In step S134, each time-series datum included in the selected unit processing data is compared with the reference data selected in step S133, and the evaluation values of each time-series datum are calculated.

After that, the evaluation values are standardized in the same way as in step S112 in the above embodiment (step S135); in addition, the evaluation value distributions 5 are created in the same way as in step S113 in the above embodiment (step S136).

Furthermore, in the variation example, the unit processing data selection step is achieved by step S130, the reference data selection step is achieved by step S131-S133, the first evaluation value calculation step is achieved by step S134, and the first evaluation value distribution creation step is achieved by step S135 and step S136. In addition, a median value datum creation step is achieved by step S131, and a score calculation step is achieved by step S132.

According to this variation example, in a case that the reference data are not determined in advance, the evaluation value distributions 5 used in abnormality judgment of the time-series data are created. In addition, when the evaluation value distributions 5 are created, the reference data are determined based on the data of the scores obtained by comparing each of the selected unit processing data with the median value datum. Because the reference data are determined is this way, a processing load is reduced compared with the first variation example. As described above, according to the variation example, in the case that the reference data are not determined in advance, the evaluation value distributions 5 can be created without high-load processing.

### 6.1.3 Third Variation Example

In the first variation example and the second variation example, relating to each recipe, time-series data included in one certain unit processing data can be adopted as reference data for all the parameters. However, time-series data included in different unit processing data can also be adopted as reference data for each parameter. For example, when attention is paid to three parameters (parameter A, parameter B, parameter C) corresponding to a certain recipe, as shown in FIG. 18, time-series data seen as the reference data for the parameter A, time-series data seen as the reference data for the parameter B, and time-series data seen as the reference data for the parameter C may be the time-series data included in the unit processing data different from each other.

Therefore, relating to step S123 in the above first variation example (see FIG. 15), the reference data may be determined (selected) for each parameter. That is, in step S123, for each parameter (each type of the time-series data), the unit processing data which are determined as the temporary reference data when the comparison value obtained in step S122 is the smallest may be selected as the reference data.

Similarly, relating to step S133 in the above second variation example (see FIG. 16), the reference data may be determined (selected) for each parameter. That is, in step S133, for each parameter (each type of the time-series data), the selected unit processing data which have the smallest (the best) score obtained in step S132 may be selected as the reference data.

### 6.2 Variation Examples Relating to Update of Evaluation Value Distributions

Next, variation examples relating to the update of the evaluation value distributions 5 are described.

### 6.2.1 Fourth Variation Example

In the above embodiment, when there is a change in the contents of the recipes, the evaluation value distributions 5 are updated. However, the disclosure is not limited to this, and the evaluation value distributions 5 may be updated each time the scoring is performed.

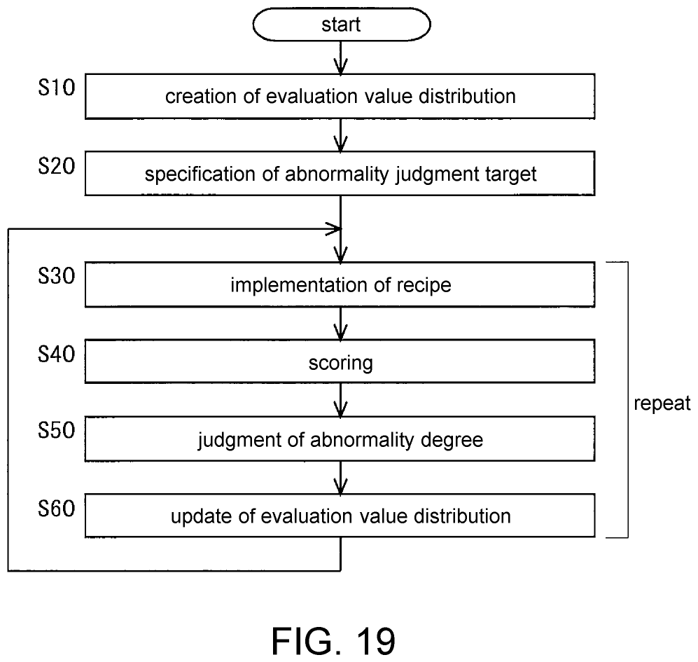

FIG. 19 is a flow chart showing an outline of an overall processing procedure of the abnormality detection that uses the time-series data in the variation example. In the above embodiment, the processing of step S30-step S50 are repeated until there is a change in the contents of any recipe (see FIG. 7). In contrast, in the variation example, after the judgment of the abnormality degrees (step S50) is carried out based on results of the scoring (step S40), the update of the evaluation value distributions 5 (step S60) is always carried out. Furthermore, a third evaluation value calculation step is achieved by step S40, and the evaluation value distribution update step is achieved by step S60.

Meanwhile, in order to create the evaluation value distributions 5, the average values and the standard deviations are required to be calculated based on all the unit processing data which are the creation sources. That is, in order to carry out the update of the evaluation value distributions 5 each time the scoring is performed, the average values and the standard deviations are required to be calculated each time the scoring is performed. Relating to this, if the average values and the standard deviations are calculated using all the unit processing data which are the creation sources of the evaluation value distributions 5 each time the scoring is performed, a load for the calculation becomes very large. Therefore, when the number of the unit processing data which are the creation sources of the evaluation value distributions 5 increases from n to n+1, the average values and the variances (squares of the standard deviations) may be obtained sequentially using the following equations (2)-(4).

$$\begin{matrix}α = \frac{1}{n + 1} & ( 2 ) \\ {μ}_{n + 1} = ( 1 - α ) {μ}_{n} + α {x}_{n + 1} & ( 3 ) \\ {σ}_{n + 1}^{2} = ( 1 - α ) {σ}_{n}^{2} + α ( 1 - α ) {( {x}_{n + 1} - {μ}_{n} )}^{2} & ( 4 )\end{matrix}$$

Here, μₙ₊₁ represents an average value of evaluation values in a state that the number of the unit processing data which are the creation sources of the evaluation value distributions 5 increases to n+1, μₙ represents an average value of the evaluation values in a state that the number of the unit processing data which are the creation sources of the evaluation value distributions 5 is n, xₙ₊₁ represents an evaluation value of the unit processing data that are added, σ²ₙ₊₁ represents a variance of the evaluation values in a state that the number of the unit processing data which are the creation sources of the evaluation value distributions 5 increases to n+1, and σ²ₙ represents a variance of the evaluation values in a state that the number of the unit processing data which are the creation sources of the evaluation value distributions 5 is n.

When μₙ₊₁ is obtained using the above equation (3), μₙ has already been obtained; in addition, when ρ²ₙ₊₁ is obtained using the above equation (4), σ²ₙ has already been obtained. Therefore, the average values and the standard deviations (the standard deviations are obtained easily from the variances) for creating an evaluation value distribution 5 after the update can be obtained with a comparatively low load.

If the number of the unit processing data which are the creation sources of the evaluation value distributions 5 is small, good accuracy cannot obtained on the abnormality judgment of the time-series data. On this point, according to the variation example, because the evaluation value distributions 5 are updated each time the scoring is performed, the accuracy of the abnormality judgment is gradually improved. In addition, although it takes some time for the average values or the standard deviations to converge to a value within a certain range (sufficient accuracy is obtained on the abnormality judgment), various setting works relating to the scoring or the creation the evaluation value distributions 5 can be carried out in advance even under the condition that no unit processing data as implementation results of the recipes is obtained.

### 6.2.2 Fifth Variation Example

In the above embodiment, the evaluation value distributions 5 are created or updated based on the unit processing data arbitrarily selected by the user. However, the disclosure is not limited to this, and the evaluation value distributions 5 may be updated based on the unit processing data obtained by the processing in the specified processing units 222.

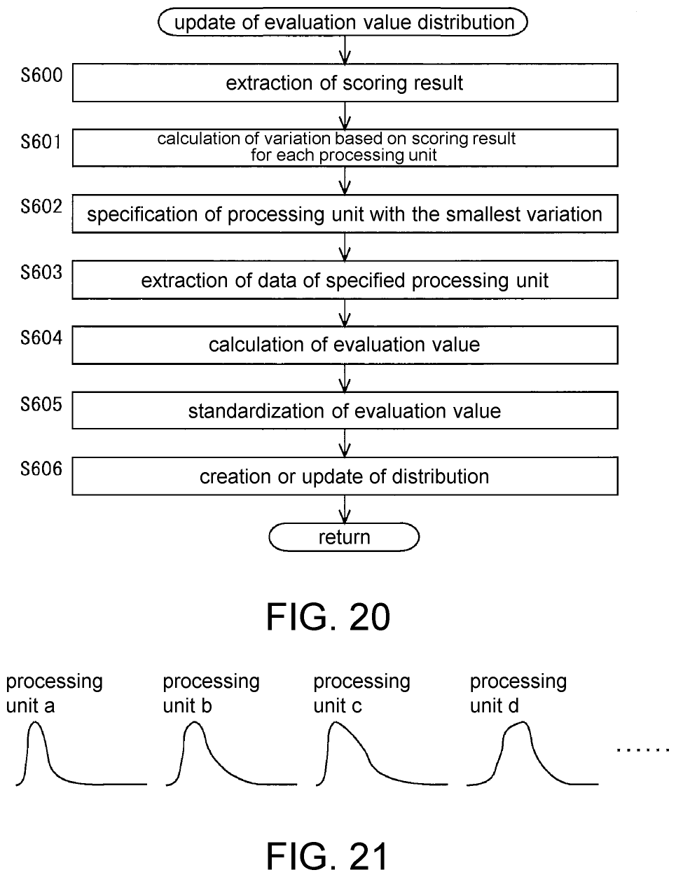

FIG. 20 is a flow chart showing a specific procedure of update of the evaluation value distributions 5 in the variation example. In the variation example, when the evaluation value distributions 5 are updated, at first, scoring results (data of the evaluation values) are extracted (step S600). In step S600, for example, the scoring results for 1000 unit processing data obtained most recently for one evaluation value distribution 5 are extracted.

Next, based on the scoring results extracted in step S600, variations (variances or standard deviations) of the evaluation values is calculated for each processing unit 222 (step S601). Furthermore, at this time, data of the evaluation values are not standardized. Meanwhile, if distributions (distributions of the evaluation values) are created based on the scoring results extracted in step S600, the distributions are, as schematically shown in FIG. 21 for example, different for each processing unit. Here, it is usually considered that, as the processing units 222 include more time-series data with high abnormality degrees in output results, the variations based on the above distributions become greater. Therefore, as described above, the variations of the evaluation values are calculated for each processing unit 222 in step S601. Then, the processing unit 222 is specified in which the smallest variation among the variations calculated in step S601 is obtained (step S602).

After that, the unit processing data obtained by the processing in the processing units 222 specified in step S602 are extracted, for example, from the 1000 unit processing data obtained most recently (step S603). Then, for each time-series datum included in the unit processing data extracted in step S603 (referred to as “extracted unit processing data” hereinafter), the evaluation values are calculated (step S604), and the evaluation values calculated in step S604 are standardized (step S605). Furthermore, the evaluation values are also standardized using the above equation (1) in step S605. At last, for each parameter (that is, each type of the time-series data), the evaluation value distribution 5 after the update is created based on the data of the evaluation values after the standardization (step S606).

Furthermore, in the variation example, a variation calculation step is achieved by step S601, a processing unit specification step is achieved by step S602, a unit processing data extraction step is achieved by step S603, a second evaluation value calculation step is achieved by step S604, and a second evaluation value distribution creation step is achieved by step S605 and step S606.

According to the variation example, even when the unit processing data which are the creation sources of the evaluation value distributions 5 are hard to be selected, the processing units 222 in which it is considered that stable processing is carried out are selected (specified) based on the scoring results of each processing unit 222. Then, the evaluation value distribution 5 after the update is created based on the unit processing data obtained by the processing of the selected processing units 222. Therefore, the abnormality judgment in which the evaluation value distributions 5 are used has a high accuracy. As described above, according to the variation example, even when the unit processing data which are the creation sources of the evaluation value distributions 5 are hard to be selected, the evaluation value distributions 5 are updated so that the abnormality judgment of the time-series data can be carried out with high accuracy.

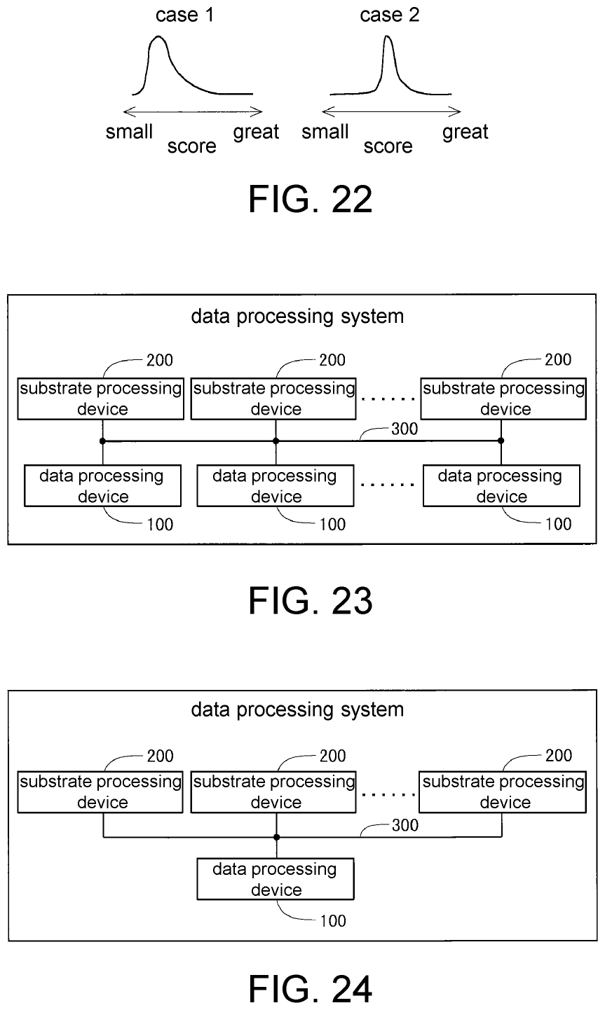

Furthermore, in the above example, the specification of the processing units 222 in step S602 is carried out only considering the variations of the evaluation values. Relating to this, as shown in FIG. 22 for example, it is also considered that there is a case in which the variations of the distributions corresponding to processing units that include many time-series data with comparatively higher abnormality degrees are smaller than the variations of the distributions corresponding to processing units that include many time-series data with comparatively lower abnormality degrees. Therefore, for example, in the above step S601 (see FIG. 20), the average values of the evaluation values may be calculated in addition to the variations of the evaluation values, and in step S602, the specification of the processing units 222 may be carried out considering both the variations of the evaluation values and the average values of the evaluation values. In this case, a statistical value calculation step is achieved by step S601.

Meanwhile, the method according to this variation example can also be adopted when the evaluation value distributions 5 are newly created. That is, relating to the processing of step S110 in the above embodiment (see FIG. 10), the unit processing data may also be selected by a procedure of steps S601-S603 in this variation example. In this way, even when the unit processing data which are the creation sources of the evaluation value distributions 5 are hard to be selected, the evaluation value distributions 5 are created so that the abnormality judgment of the time-series data can be carried out with high accuracy.

### 6.3 Variation Example Relating to Overall Configuration of Data Processing System (Sixth Variation Example)

In the above embodiment, the data processing system is configured by one substrate processing device 200 and one data processing device 100 corresponding to the substrate processing device 200. However, the disclosure is not limited to this. For example, as shown in FIG. 23, the data processing system may also be configured by a plurality of substrate processing devices 200 and a plurality of data processing devices 100 in a one to one correspondence, or as shown in FIG. 24, the data processing system may also be configured by a plurality of substrate processing devices 200 and one data processing device 100. That is, a plurality of substrate processing devices 200 may be included in the data processing system.

In addition, in the data processing system including a plurality of substrate processing devices 200, the evaluation value distributions 5 for any parameter may be prepared for each substrate processing device 200. That is, each evaluation value distribution 5 created by the data processing device 100 may be used as the evaluation value distribution 5 for the substrate processing device 200 that corresponds to the data processing device 100 among the plurality of substrate processing devices 200. In this case, the evaluation value distribution 5 for a certain substrate processing device 200 in the data processing system may be replicated as the evaluation value distribution 5 for another substrate processing device 200. That is, the evaluation value distribution 5 for any substrate processing device 200 may be exported, or the evaluation value distribution 5 may be imported as the evaluation value distribution 5 of any substrate processing device 200.

According to this variation example, the evaluation value distribution 5 based on good data can be shared among the plurality of substrate processing devices 200. In this way, the accuracy of the abnormality detection that uses the time-series data can be stabilized.

### 6.4 Variation Example Relating to Correspondence Between Evaluation Value Distributions and Processing Units (Seventh Variation Example)

In the above embodiment, the evaluation value distributions 5 common to all the processing units 222 are created for each parameter. However, the disclosure is not limited to this, and the evaluation value distributions 5 for each parameter may be created for each processing unit 222. That is, each evaluation value distribution 5 created by the data processing device 100 may be used as the evaluation value distribution 5 for any one of the plurality of processing units 222. In this case, the evaluation value distribution 5 for a certain processing unit 222 may be replicated as the evaluation value distribution 5 for another processing unit 222. That is, the evaluation value distributions 5 for any processing unit 222 may be exported, or the evaluation value distributions 5 may be imported as the evaluation value distributions 5 of any processing unit 222.

According to this variation example, the evaluation value distributions 5 based on good data can be shared among the plurality of processing units 222. In this way, the accuracy of the abnormality detection that uses the time-series data can be stabilized.

### 7. Others

In the above, the disclosure is specifically described, but the above description is illustrative in all aspects and is not limitative. It is understood that numerous other changes or variations can be devised without departing from the range of the disclosure.

What is claimed is:

1. A data processing method, in which a plurality of types of time-series data obtained by unit processing is taken as unit processing data and a plurality of unit processing data is processed, the method comprising:
a unit processing data selection step, in which two or more unit processing data are selected from the plurality of unit processing data;
a first evaluation value calculation step, in which evaluation values of each time-series datum included in selected unit processing data which are the unit processing data selected in the unit processing data selection step are calculated; and
a first evaluation value distribution creation step, in which evaluation value distributions showing degrees of each value of the evaluation values are created for each type of the time-series data based on the evaluation values of each time-series datum calculated in the first evaluation value calculation step.

2. The data processing method according to claim 1, further comprising a reference data selection step, in which reference data which become reference when the evaluation values are calculated are selected from the plurality of unit processing data,
wherein in the first evaluation value calculation step, calculations of the evaluation values are carried out by comparing each time-series datum included in the selected unit processing data with the reference data selected in the reference data selection step.

3. The data processing method according to claim 2, wherein the reference data selection step comprises:
a temporary reference data setting step, in which one of the selected unit processing data is determined as temporary reference data; and
a comparison value calculation step, in which average values or total values of the evaluation values obtained by comparing the temporary reference data with each of the unit processing data other than the temporary reference data among the selected unit processing data are obtained as comparison values; and
in the reference data selection step,
the temporary reference data setting step and the comparison value calculation step are repeated until all of the selected unit processing data are determined once as the temporary reference data; and
the unit processing data, which is determined as the temporary reference data when the smallest comparison value is obtained in the comparison value calculation step, are selected as the reference data.

4. The data processing method according to claim 3, wherein in the reference data selection step, for each type of the time-series data, the unit processing data determined as the temporary reference data when the smallest comparison value is obtained in the comparison value calculation step are selected as the reference data.

5. The data processing method according to claim 2, wherein the reference data selection step comprises:
a median value data creation step, in which median value data including data of median values at each time point of the selected unit processing data are created for each type of the time-series data; and
a score calculation step, in which scores equivalent to the evaluation values of each of the selected unit processing data are obtained for each type of the time-series data by comparing each of the selected unit processing data with the median value data; and wherein
in the reference data selection step, the selected unit processing data which have the best total value of the scores obtained for each type of the time-series data are selected as the reference data.

6. The data processing method according to claim 2, wherein the reference data selection step comprises:
a median value data creation step, in which median value data including data of median values at each time point of the selected unit processing data are created for each type of the time-series data; and
a score calculation step, in which scores equivalent to the evaluation values of each of the selected unit processing data are obtained for each type of the time-series data by comparing each of the selected unit processing data with the median value data; and wherein
in the reference data selection step, the selected unit processing data which have the best scores obtained for each type of the time-series data in the score calculation step are selected as the reference data.

7. The data processing method according to claim 2, wherein the unit processing is implemented as one recipe on one piece of substrate by a substrate processing device having a plurality of processing units, and
selection of the reference data in the reference data selection step is carried out from the unit processing data extracted by specifying at least one of periods, processing units, and recipes.

8. The data processing method according to claim 1, wherein the unit processing is implemented as one recipe on one piece of substrate by a substrate processing device having a plurality of processing units, and
selection of the unit processing data in the unit processing data selection step is carried out from the unit processing data extracted by specifying at least one of periods, processing units, and recipes.

9. The data processing method according to claim 1, wherein in the first evaluation value calculation step, calculations of the evaluation values are carried out by comparing each time-series datum included in the selected unit processing data with the reference data determined in advance.

10. The data processing method according to claim 1, wherein
the unit processing is implemented as one recipe on one piece of substrate by a substrate processing device having a plurality of processing units;
the unit processing data selection step comprises:
a variation calculation step, in which variations of the evaluation values are calculated for each processing unit based on the evaluation values of each time-series datum;
a processing unit specification step, in which a processing unit is specified in which the smallest variation among the variations calculated in the variation calculation step is obtained; and
a unit processing data extraction step, in which the unit processing data corresponding to the processing unit specified in the processing unit specification step are extracted as the two or more unit processing data.

11. The data processing method according to claim 1, wherein in the first evaluation value distribution creation step, standardization of the evaluation values calculated in the first evaluation value calculation step is carried out, and the evaluation value distributions are created based on the evaluation values after the standardization.

12. The data processing method according to claim 1, further comprising an evaluation value distribution update step, in which the evaluation value distributions are updated.

13. The data processing method according to claim 12, wherein
the unit processing is implemented as one recipe on one piece of substrate by a substrate processing device having a plurality of processing units;
the evaluation value distribution update step comprises:
a variation calculation step, in which variations of the evaluation values are calculated for each processing unit based on the evaluation values of each time-series datum;
a processing unit specification step, in which the processing unit is specified in which the smallest variation among the variations calculated in the variation calculation step is obtained;
a unit processing data extraction step, in which the unit processing data corresponding to the processing unit specified in the processing unit specification step are extracted from the plurality of unit processing data;
a second evaluation value calculation step, in which evaluation values of each time-series datum included in extracted unit processing data which are the unit processing data extracted in the unit processing data extraction step are calculated; and
a second evaluation value distribution creation step, in which an evaluation value distribution after update is created for each type of the time-series data based on the evaluation values of each time-series datum calculated in the second evaluation value calculation step.

14. The data processing method according to claim 12, wherein
the unit processing is implemented as one recipe on one piece of substrate by a substrate processing device having a plurality of processing units;
the evaluation value distribution update step comprises:
a statistical value calculation step, in which average values and variations of the evaluation values are calculated for each processing unit based on the evaluation values of each time-series datum;
a processing unit specification step, in which the processing unit is specified considering the average values and the variations calculated in the statistical value calculation step;
a unit processing data extraction step, in which the unit processing data corresponding to the processing unit specified in the processing unit specification step are extracted from the plurality of unit processing data;
a second evaluation value calculation step, in which evaluation values of each time-series datum included in extracted unit processing data which are the unit processing data extracted in the unit processing data extraction step are calculated; and
a second evaluation value distribution creation step, in which an evaluation value distribution after update is created for each type of the time-series data based on the evaluation values of each time-series datum calculated in the second evaluation value calculation step.

15. The data processing method according to claim 12, wherein the plurality of unit processing data is obtained by implementing recipes by a substrate processing device;
a third evaluation value calculation step is further included, in which in order to judge abnormality degrees of time-series data included in the unit processing data newly obtained by the implementation of the recipes, evaluation values of the time-series data included in the newly obtained unit processing data are calculated; and
the evaluation value distribution update step is implemented each time the third evaluation value calculation step is implemented.

16. The data processing method according to claim 12, wherein the plurality of unit processing data is obtained by implementing recipes by a substrate processing device; and
the evaluation value distribution update step is implemented when there is a change in contents of the recipes.

17. The data processing method according to claim 16, wherein the plural types of time-series data are time-series data of a plurality of parameters;
in the first evaluation value distribution creation step, the evaluation value distributions are created for each parameter; and
in the evaluation value distribution update step, only the evaluation value distribution corresponding to the parameter with the change in the contents is updated.

18. The data processing method according to claim 17, wherein in the evaluation value distribution update step, the evaluation value distributions corresponding to the parameters added along with the change of the contents of the recipes are created based on data of the evaluation values already accumulated.

19. The data processing method according to claim 17, wherein in the evaluation value distribution update step, the evaluation value distributions corresponding to the parameters specified from outside are recreated.

20. A data processing device, which takes a plurality of types of time-series data obtained by unit processing as unit processing data and processes a plurality of unit processing data, the data processing device comprising:
a unit processing data selection part, which selects two or more unit processing data from the plurality of unit processing data;
an evaluation value calculation part, which calculates evaluation values of each time-series datum included in selected unit processing data which are the unit processing data selected by the unit processing data selection parts; and
an evaluation value distribution creation part, which creates evaluation value distributions showing degrees of each value of the evaluation values for each type of the time-series data based on the evaluation values of each time-series datum calculated by the evaluation value calculation part.

21. The data processing device according to claim 20, wherein the unit processing is implemented as one recipe on one piece of substrate by a substrate processing device having a plurality of processing units;
the evaluation value distributions created by the evaluation value distribution creation part are used as the evaluation value distributions for any one of the plurality of processing units, and
the evaluation value distributions for a certain processing unit can be replicated as the evaluation value distributions for other processing units.

22. A data processing system, which takes a plurality of types of time-series data obtained by unit processing implemented by a substrate processing device as unit processing data and processes a plurality of unit processing data, and which comprises a plurality of substrate processing devices, comprising:
a unit processing data selection part, which selects two or more unit processing data from the plurality of unit processing data;
an evaluation value calculation part, which calculates evaluation values of each time-series datum included in selected unit processing data which are the unit processing data selected by the unit processing data selection part; and
an evaluation value distribution creation part, which creates evaluation value distributions showing degrees of each value of the evaluation values for each type of the time-series data based on the evaluation values of each time-series datum calculated by the evaluation value calculation part.

23. The data processing system according to claim 22, wherein the evaluation value distributions created by the evaluation value distribution creation parts are used as the evaluation value distributions for any one of the plurality of substrate processing devices, and
the evaluation value distributions for a certain substrate processing device can be replicated as the evaluation value distributions for other substrate processing devices.

24. A non-transitory computer-readable recording medium, in which a data processing program is stored to make a computer that is included in a data processing device that takes a plurality of types of time-series data obtained by unit processing as unit processing data and processes a plurality of unit processing data, to implement
a unit processing data selection step, in which two or more unit processing data are selected from the plurality of unit processing data;
an evaluation value calculation step, in which evaluation values of each time-series datum included in selected unit processing data which are the unit processing data selected in the unit processing data selection step are calculated; and
an evaluation value distribution creation step, in which evaluation value distributions showing degrees of each value of the evaluation values are created for each type of the time-series data based on the evaluation values of each time-series datum calculated in the evaluation value calculation step.
